(19) United States
(12) Patent Application Publication
(10) Pub. No.: US 2026/0245955 A1
(43) Pub. Date: Aug. 20, 2026

(54) MXENE ELECTRODES FOR HIGH-PERFORMANCE FLEXIBLE ENERGY STORAGE

(71) Applicant: Northwestern University, Evanston, IL (US)

(72) Inventors: Vinayak P. Dravid, Glenview, IL (US); Xiaobing Hu, Evanston, IL (US); Yongfa Cheng, Evanston, IL (US)

(21) Appl. No.: 19/541,938

(22) Filed: Feb. 17, 2026

Related U.S. Application Data
(60) Provisional application No. 63/760,054, filed on Feb. 18, 2025.

(51) Int. Cl. H01M 10/0525; H01G 11/36; H01M 4/134

(52) U.S. Cl. CPC H01M 10/0525; H01G 11/36; H01M 4/134; C01P 2004/03

(57) ABSTRACT

Provided are compositions comprising (or consisting of) holey MXene nanosheets. Electrodes comprising (or consisting of) such compositions are also provided as are energy storage devices and systems comprising the electrodes. In embodiments, a composition comprises a plurality of holey MXene nanosheets, each holey MXene nanosheet composed of one or more monolayers of MXene, wherein surfaces of the MXene define a plurality of nanoscale holes distributed laterally throughout each holey MXene nanosheet.

### CROSS-REFERENCE TO RELATED APPLICATION

The present application claims priority to U.S. Provisional Patent Application No. 63/760,054 filed on Feb. 18, 2025, the entire disclosure of which is incorporated herein by reference.

### REFERENCE TO GOVERNMENT RIGHTS

This invention was made with government support under grant number DE-SC0024256 awarded by the Department of Energy, and grant number ECCS2025633 awarded by the National Science Foundation. The government has certain rights in the invention.

### BACKGROUND

With the continuous advancement of electrochemical energy storage technologies, there is an urgent demand for high-performance electrode materials. MXenes, an emerging class of two-dimensional materials, have shown tremendous potential in this field due to their unique layered structure and excellent electrical conductivity. However, despite these advantages, the practical application of MXenes faces several critical challenges, including poor mechanical properties, limited electrochemical capacity, and susceptibility to oxidation. Regarding oxidation, not only does this process degrade MXene's structural integrity, it also leads to corrosion, severely limiting the long-term stability and reliability of MXene-based devices. To mitigate this issue, researchers have been working on attaining oxidation resistance by modifying surface functional groups and developing novel MXene composites. For instance, modifying the MXene surface with protective layers or introducing antioxidant agents has shown promise in mitigating oxidation effects and improving device longevity.

### SUMMARY

Provided are electrodes comprising (or consisting of) holey MXene nanosheets. Energy storage devices and systems comprising the electrodes are also provided. The present disclosure is based, at least in part, on the inventors' discovery of a controlled oxidation process that may be leveraged to create high-performance holey MXene nanosheets for use as electrodes in various energy storage devices. This approach is counterintuitive and the results are surprising since oxidation has been believed to degrade the performance of MXenes. Compositions comprising (or consisting of) the holey MXene nanosheets themselves are also provided.

The present disclosure is illustrated by reference to an Example, below, in which an illustrative controlled oxidation process was used to create nanoscale holes within MXene nanosheets, transforming them into holey MXene (H-MXene) nanosheets. It is shown that the pores shorten ion transport distances and increase ion transport pathways, thereby significantly enhancing the electrochemical storage capacity of MXenes. Micro-supercapacitors (MSCs) incorporating the MXene nanosheets demonstrate exceptional performance, achieving an areal capacitance 2.5 times that of comparative MSCs incorporating unmodified MXene nanosheets, along with excellent cycling stability, retaining 91.7% of their capacitance after 10,000 cycles. As noted above, these results are surprising and unexpected in view of the conventional wisdom that oxidation degrades MXene performance. The Example, below, further describes a flexible integrated system combining energy storage and sensing functionalities, showcasing its scalability in self-powered sensing applications. The incorporation of self-healing polyurethane (PU) into the system enables the energy storage device to retain 90% of its storage capacity after undergoing self-healing.

In embodiments, a composition comprises a plurality of holey MXene nanosheets, each holey MXene nanosheet composed of one or more monolayers of MXene, wherein surfaces of the MXene define a plurality of nanoscale holes distributed laterally throughout each holey MXene nanosheet.

Electrodes comprising the holey MXene nanosheets are provided as well as energy storage devices comprising the electrodes and electrochemical systems comprising the energy storage devices. Methods of storing energy using the energy storage devices are also provided. Methods of fabricating holey MXene nanosheets and methods of fabricating the electrodes are also provided.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIGS. 1A-1I. Synthesis and structural evolution of H-MXene. FIG. 1A shows a schematic of the process for transforming MXene to H-MXene. FIGS. 1B, 1C show a TEM image and corresponding SAED patterns of pristine MXene (P-MXene) nanosheets. FIGS. 1D, 1E show a TEM image and corresponding SAED patterns of H-MXene that had been treated with 50 μL H₂O₂. FIGS. 1F, 1G show a TEM image of fully oxidized MXene (TiO₂) and the corresponding SAED patterns. FIG. 1H shows electron diffraction data at different angles for fully oxidated MXene. FIG. 1I shows rotational average of the electron diffraction data for fully oxidated MXene.

FIGS. 2A-2H. H-MXene micro-supercapacitors (MSCs) and material characterizations. FIGS. 2A-2B show SEM images of the MAX phase (Ti₃AlC₂) powder (FIG. 2A), and MXene (Ti₃C₂Tₓ) nanosheets (FIG. 2B). FIG. 2C shows an AFM image of a MXene nanosheet having a thickness of 1.55 nm. FIG. 2D shows a TEM image of H-MXene that had been treated with 150 μL H₂O₂. FIG. 2E shows a SEM image of H-MXene patterned into interdigitated electrodes using laser etching. A full image of the laser-etched H-MXene interdigitated electrodes is shown in the upper right corner. FIG. 2F shows a high-resolution high-angle annular dark-field imaging (HAADF) image of a cross-section of H-MXene and associated profile diagram. FIG. 2G shows a schematic diagram of flexible energy storage devices that can worn as wearable electronics. FIG. 2H is another image showing how the flexible storage devices may be used.

FIGS. 3A-3H. Electrochemical performance of pristine MXene (P-MXene) and H-MXene MSCs having different degrees of oxidation. FIG. 3A shows CV curves of P-MXene and H-MXene MSCs at a scan rate of 20 mV s⁻¹. FIG. 3B shows GCD curves of P-MXene and H-MXene MSCs at a charge and discharge rate of 2 mA cm⁻². FIG. 3C shows capacitance at various current densities. FIGS. 3D-3E show capacities of all samples at different scan rates (FIG. 3D) and charge and discharge rates (FIG. 3E). FIG. 3F shows a Nyquist plot. FIG. 3G shows a Bode phase plot. FIG. 3H is a schematic illustration of the mechanism of enhanced electrochemical performance by H-MXene.

FIGS. 4A-4E. Performance of an optimized H-MXene MSC and integrated sensing system. FIG. 4A shows CV curves. FIG. 4B shows GCD curves. FIG. 4C shows capacitance retention rate after 10,000 cycles. FIG. 4D shows a comparison of power density and energy density among different MSCs, including one based on the optimized H-MXene according to the present disclosure. FIG. 4E is a schematic of an integrated sensing system including a H-MXene pressure sensor and a H-MXene MSC.

FIGS. 5A-5C. Multifunctionality of the H-MXene MSCs. FIGS. 5A-5B show CV (FIG. 5A) and GCD (FIG. 5B) curves under different bending angles. FIG. 5C shows capacitance retention of the H-MXene MSC before and after self-healing.

FIGS. 6A-6B. FIG. 6A is a schematic of the synthesis process of H-MXene. FIG. 6B is a schematic of the preparation of MSCs made with H-MXene electrodes.

FIGS. 7A-7B show the results from BET (Brunauer-Emmett-Teller) and BJH (Barrett-Joyner-Halenda) pore analyses of MXene samples before and after oxidation treatment. FIG. 7A shows the BET surface area measurements from pristine MXene and MXene oxidized using different amounts of H₂O₂. FIG. 7B shows the pore volume/size distributions of the samples.

### DETAILED DESCRIPTION

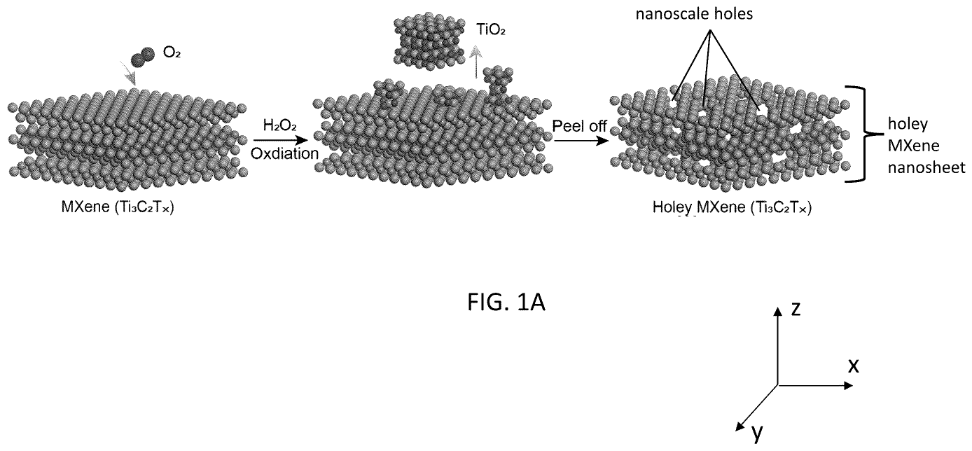

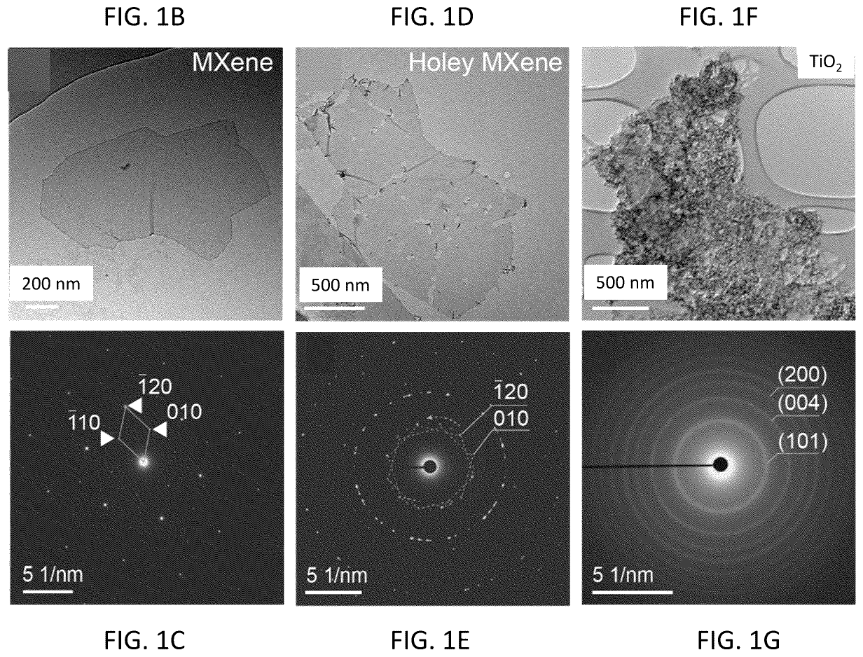

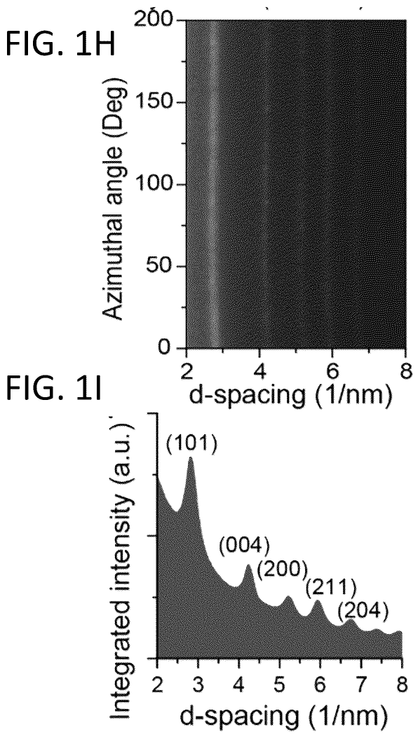

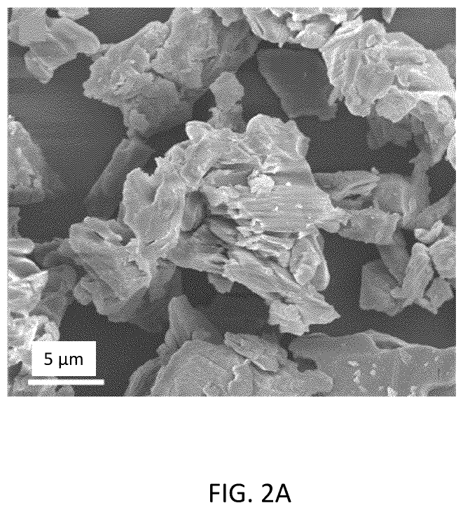

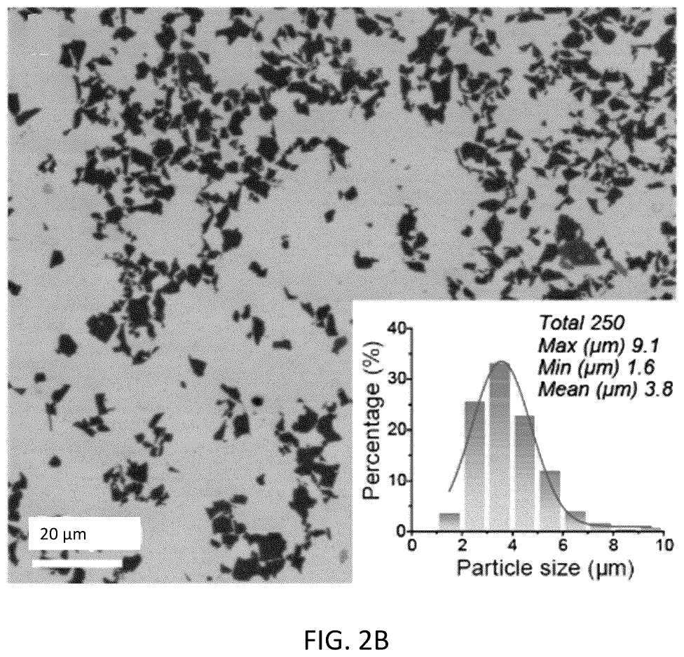

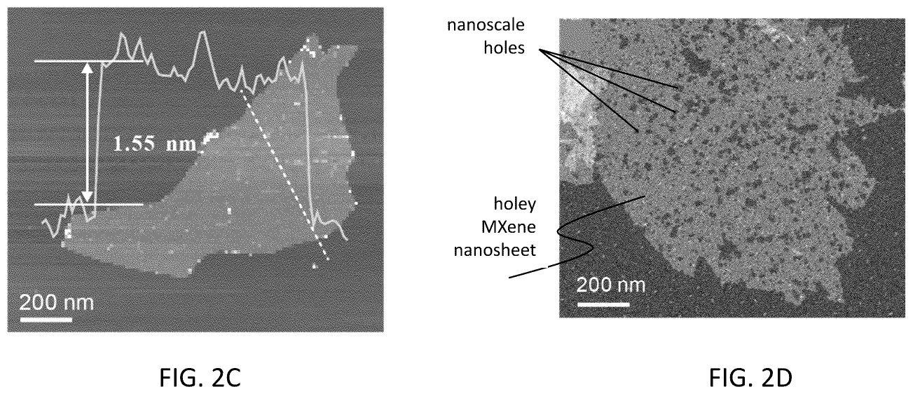

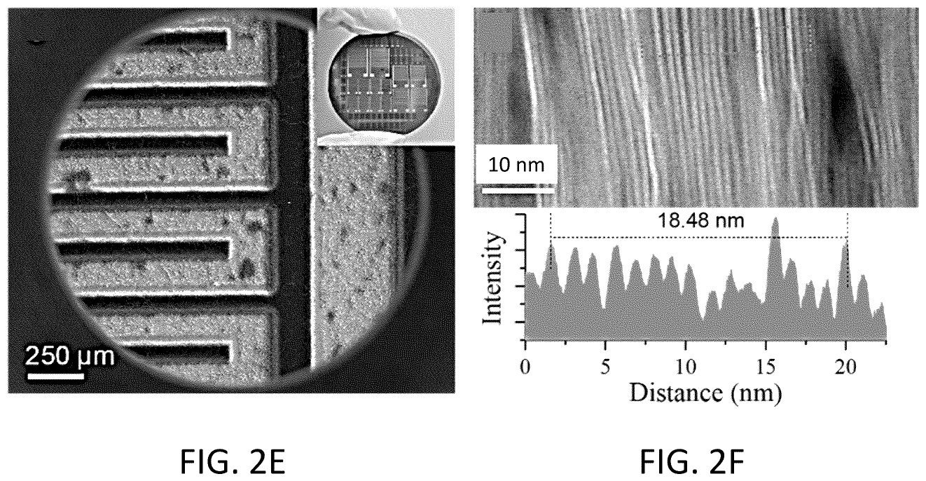

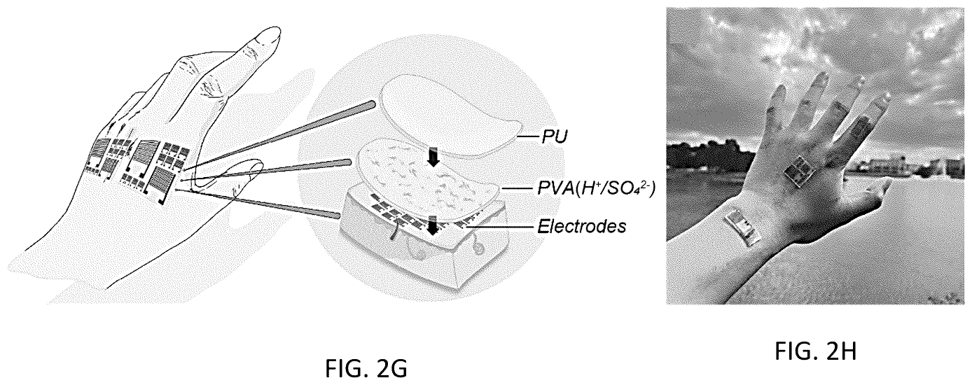

Provided are electrodes comprising holey MXene nanosheets. Each holey MXene nanosheet, an illustrative one of which is shown in FIG. 2D, refers to a two-dimensional (2D), planar structure composed of one or more (but generally not more than a few, e.g., 1, 2, 3, 4, 5) MXene monolayers. Surfaces of the MXene solid matrix define a plurality of nanoscale holes distributed throughout each holey MXene nanosheet. (See also the schematic of a holey MXene nanosheet in the rightmost image of FIG. 1A.) The present electrodes may consist of any of the disclosed holey MXene nanosheets, and optionally, an additive. The additive may be selected from a binder, a conductive material (e.g., carbon nanotubes, graphene, carbon black, metal nanowires), an antioxidant (e.g., ascorbic acid), a surfactant, a self-healing agent (e.g., polyurethane), or combinations thereof.

The term “MXene” refers to the class of transition metal carbides, nitrides, and carbonitrides that forms the solid matrix of the holey MXene nanosheets, the surfaces of which define the plurality of nanoscale holes. The MXene may be characterized by the formula Mₙ₊₁XₙTₓ, wherein M is a transition metal (e.g., a transition metal selected from Sc, Ti, V, Cr, Y, Zr, Nb, Mo, Hf, Ta, W, and combinations thereof); X is carbon (C), nitrogen (N), or both are present; and T is a surface group (e.g., a surface group selected from a halogen (e.g., —F, —Cl, —I, —Br), a chalcogen (e.g., —O, —S, —Se, —Te), —H, —OH, —NH₂, and combinations thereof. In this formula, “-” denotes a bond to the carbide/nitride/carbonitride or the transition metal thereof. The value n refers to the number of carbide/nitride/carbonitride octahedral blocks in each monolayer of the MXene. In embodiments, n is in a range of from 1 to 4, including 1, 2, 3, or 4. The value x refers to the number of surface groups per carbide/nitride/carbonitride chemical formula (Mₙ₊₁+Xₙ). The value of x may be in a range of from 0 to 2, including 0, 1, or 2. In embodiments, the MXene has formula Mₙ₊₁CₙTₓ, wherein M is selected from Ti, V, Cr, Nb, and combinations thereof. In embodiments, the MXene is Ti₃C₂Tₓ.

The holey MXene nanosheets have a nanoscale thickness and substantially greater lateral dimensions than the nanoscale thickness. Referring to the legend shown in FIG. 1A, thickness is measured along the z axis while the lateral dimensions are measured within the xy plane. The nanoscale thickness of a holey MXene nanosheet depends upon the number of MXene monolayers therein (the thickness of a MXene monolayer is about 1.55 nm). Thus, the nanoscale thickness of a holey MXene nanosheet may be, e.g., in a range of from about 1.55 nm to 10 nm, while the lateral dimensions may be in a range of from 1 mm to 50 mm (e.g., from 1 mm to 25 mm or from 1 mm to 10 mm). These dimensions may be quantified using scanning electron microscopy (SEM) and/or atomic force microscopy (AFM) as described in the Example, below, and may be average values as determined from a representative number of holey MXene nanosheets. (See also, FIG. 2B (showing a top view of a collection of MXene nanosheets showing that the average maximum lateral dimension of a MXene nanosheet in this collection is about 3.8 mm) and FIG. 2C (an individual MXene nanosheet having a thickness of about a monolayer).)

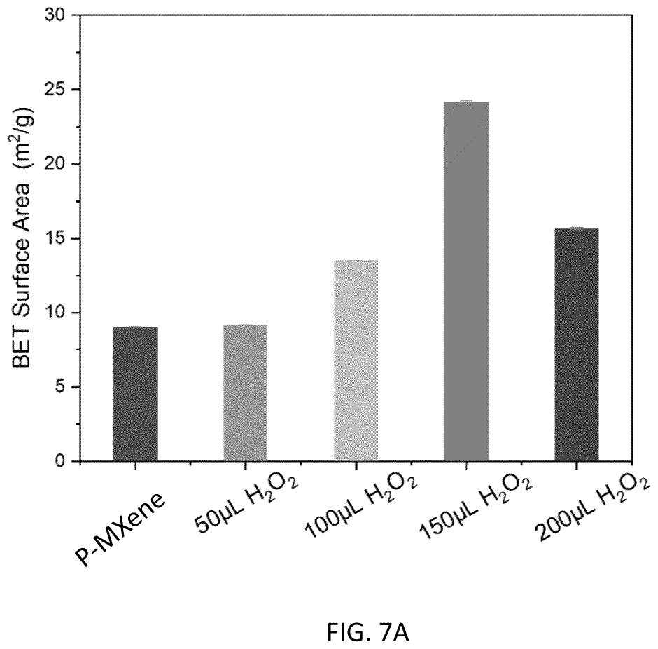

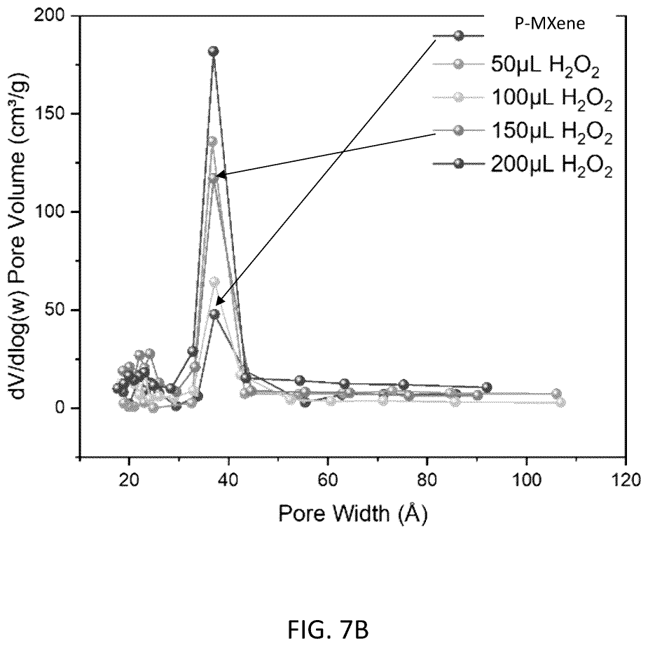

As shown in FIG. 2D, the nanoscale holes in the holey MXene nanosheets have all three dimensions which are nanoscale. The lateral dimensions of each nanoscale hole correspond to those within the plane defined by the holey MXene nanosheet (i.e., as measured within the xy plane), while the depth of each nanoscale hole corresponds to the dimension perpendicular to this plane (i.e., as measured along the z axis). Thus, for nanoscale holes that completely penetrate the holey MXene nanosheet from its top surface to its bottom surface, the depth of such nanoscale holes corresponds to the nanoscale thickness of the holey MXene nanosheet as described above. The shape of the nanoscale holes may be spherical or ellipsoidal but these terms encompass irregular shapes that approximate a sphere or ellipsoid. The diameters (or major radii) of such nanoscale holes may be in a range of from 1 nm to 100 nm. This includes from 1 nm to 50 nm, from 1 nm to 25 nm, from 1 nm to 15 nm, from 1 nm to 10 nm, from 1 nm to 5 nm, from 2 nm to 5 nm, and other ranges formed between any of these numbers. These dimensions may be average values as determined using Brunauer-Emmett-Teller (BET) and Barrett-Joyner-Halenda (BJH) pore analysis as described in the Example, below. These techniques may be used to determine the surface area of the holey MXene nanosheets, which may be at least 15 m²/g, at least 20 m²/g, at least 25 m²/g, or a range between any of these values. (See FIG. 7A.) The holey MXene nanosheets may also be characterized by a porosity (pore volume) as determined from TEM images, which may be in a range of from 5.8% to 26.3%. This includes from 12% to 22%, from 15% to 20%, and other ranges formed between any of these numbers.

The nanoscale holes of the MXene nanosheet are distinguished from spacings that may present between the individual atoms from which the solid matrix (e.g., Mₙ₊₁CₙTₓ) of the MXene nanosheet is composed, at least by the nanoscale holes having different shapes/dimensions. Thus, a MXene nanosheet that has not been subjected to the oxidation treatment as described herein to provide the plurality of nanoscale holes cannot be considered to be a holey MXene nanosheet, nor can it be considered to be porous as these terms have been defined herein. In addition, a holey MXene nanosheet may be characterized as having, e.g., a greater BET surface area, a greater BET pore volume, etc., as compared to a pristine MXene nanosheet. The term “pristine (P)” refers to a MXene nanosheet formed using the same technique as the holey MXene nanosheet but which has not been subjected to any of the oxidation treatments described herein. In embodiments, the holey MXene nanosheet has a BET surface area/BET pore volume that is as least 2 times, at least 2.5 times, at least 3 times greater, or a range between any of these values, than that of a pristine MXene nanosheet. (See FIGS. 7A and 7B, respectively.)

Illustrative MXene compositions, nanosheet morphologies, and nanoscale hole morphologies have been provided above. However, in general, selection of these physical features depends upon the application for the present electrodes. Selection may also be made to achieve a particular electrochemical result, e.g., maximum areal capacitance for a supercapacitor comprising the present electrodes.

It is to be understood that compositions comprising (or consisting of) any of the disclosed holey MXene nanosheets are also encompassed by the present disclosure, whether or not those compositions are configured as the disclosed electrodes.

Methods for fabricating the holey MXene nanosheets are also encompassed by the present disclosure, the conditions of which may be adjusted to achieve any of the electrode characteristics/properties described herein. In an embodiment, such a method comprises exposing a MXene nanosheet to an oxidizing agent under conditions to induce formation of nanoscale holes within the MXene solid matrix of the MXene nanosheet. As illustrated in FIG. 1A, the oxidizing agent oxidizes the transition metal in the MXene solid matrix, forming metal oxides, which desorb from the MXene nanosheet, leaving behind nanoscale holes formed within the MXene solid matrix.

The conditions being used in the method include parameters such as the type of oxidizing agent, the concentration of the oxidizing agent, as well as the temperature and time at which the exposure occurs. As described in the Example, below, these conditions may be selected to achieve sufficient oxidation to form the desired nanoscale holes having the desired characteristics but to avoid excessive oxidation, which converts the MXene nanosheet to a plurality of individual, discrete nanoparticles.

The conditions may also be selected to achieve a particular electrochemical result, e.g., maximum areal capacitance. FIG. 2D shows a holey MXene nanosheet fabricated using optimal oxidation conditions, while FIG. 1F illustrates the result of using conditions that lead to excessive oxidation and convert the MXene nanosheet to a plurality of individual, discrete nanoparticles. The composition of these nanoparticles may be the metal oxide corresponding to the MXene, e.g., for Ti₃C₂Tₓ, the metal oxide is TiO₂.

Illustrative oxidation agents and conditions are provided in the Example, below. This includes use of a peroxide (e.g., H₂O₂ at 30 vol % H₂O₂ and 70 vol % distilled water); volumes of the peroxide (e.g., H₂O₂ 30/70 v/v) of from 50 mL to 200 mL (including 50 μL, 55 μL, 60 μL, 65 μL, 70 μL, 75 μL, 80 μL, 85 μL, 90 μL, 95 μL, 100 μL, 105 μL, 110 μL, 115 μL, 120 μL, 125 μL, 130 μL, 135 μL, 140 μL, 145 μL, 150 μL, 155 μL, 160 μL, 165 μL, 170 μL, 175 μL, 180 μL, 185 μL, 190 μL, 195 μL, 200 μL, and a range between any of these numbers); a temperature of room temperature or from 25° C. to 70° C. (including 30° C., 35° C., 40° C., 45° C., 50° C., 55° C., 60° C., 65° C., and a range between any of these numbers); and a time of 5 min to 60 min (including 10 min, 15 min, 20 min, 25 min, 30 min, 35 min, 40 min, 45 min, 50 min, 55 min, and a range between any of these numbers). This further includes exposing the MXene nanosheet to a peroxide (e.g., H₂O₂) at a concentration in a range of from 7.5 mM to 11.5 mM, from 8 mM to 11 mM, from 8.5 mM to 10.5 mM, or from 9 mM to 10 mM (all other conditions may be selected as described in this paragraph).

Further regarding oxidation agents, other peroxides may be used including organic peroxides (e.g., benzoyl peroxide, tert-butyl hydroperoxide) and inorganic peroxides (e.g., sodium peroxide, barium peroxide). The concentration of such peroxides may be any of those disclosed above. When using such other peroxides, all other conditions may be selected as described above.

The conditions being used during fabrication of the holey MXene nanosheets may further include using an acid or a base as a pH-regulating agent. This includes using the acid or the base to adjust the pH of the oxidation agent. An auxiliary etchant may also be used. The acid/base/auxiliary etchant provides additional control over the density, size, and distribution of the plurality of nanoscale holes.

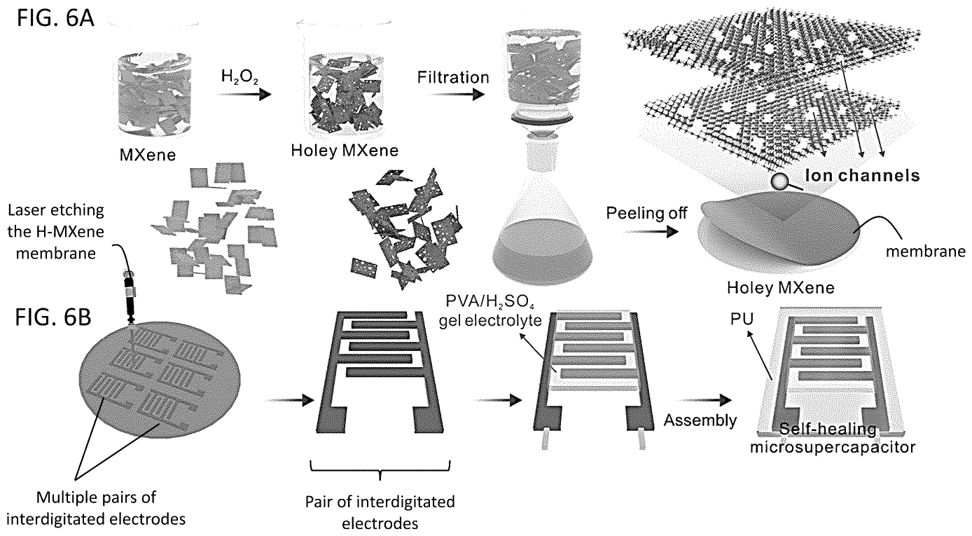

An illustrative method for forming an electrode from the holey MXene nanosheets is illustrated in FIG. 6A. First, holey MXene nanosheets are fabricated by exposing MXene nanosheets to an oxidizing agent (e.g., H₂O₂) as described above and in detail in the Example, below. Next, an aqueous dispersion of the holey MXene nanosheets is filtered to form a membrane composed of a plurality of holey MXene nanosheets. As shown in FIG. 6B, and described in detail in the Example, below, the membrane may be patterned (e.g., via laser etching/engraving) to form one or more electrodes having any desired shapes and dimensions. In this embodiment, the membrane is patterned to form pairs of interdigitated electrodes.

The present electrodes may be used in a variety of energy storage devices, e.g., supercapacitors. In an embodiment, an energy storage device comprises an electrode comprising a plurality of holey MXene nanosheets, an electrolyte forming an interface with the surfaces of the electrode, and a counter electrode in electrical communication with the electrode. The electrolyte may form another interface with the counter electrode. The counter electrode may also comprise a plurality of holey MXene nanosheets.

An illustrative energy storage device, a supercapacitor, is also shown in FIG. 6B. This supercapacitor (also referred to as a micro-supercapacitor, MSC, in the Example, below) includes an electrode composed of holey Ti₃C₂Tₓ nanosheets; a gel electrolyte composed of polyvinyl alcohol (PVA) and H₂SO₄; and a counter electrode also composed of holey Ti₃C₂Tₓ nanosheets. Other gel electrolytes may be used. The electrode and the counter electrode are formed as a pair of interdigitated electrodes as described above. The supercapacitor further includes a coating of polyurethane (PU) on the electrode, the gel electrolyte, and the counter electrodes. This coating protects the supercapacitor and renders it self-healing as further described in the Example, below.

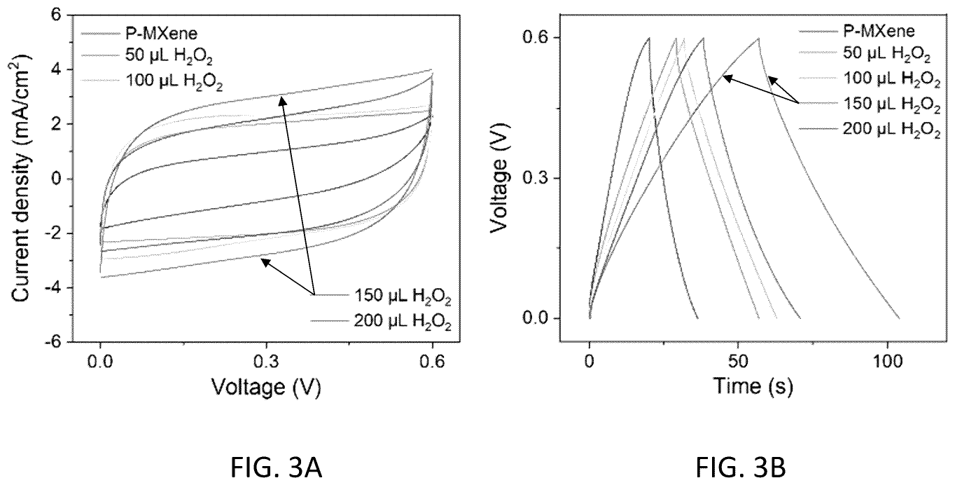

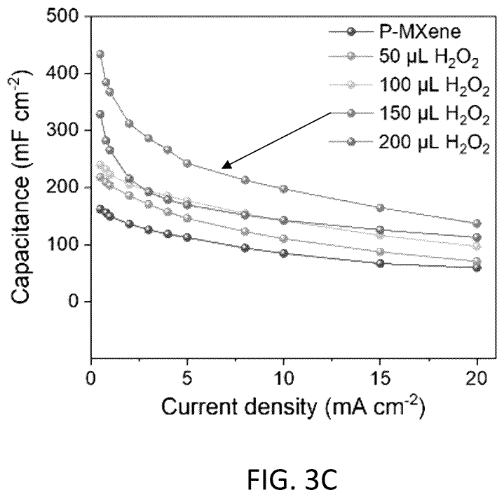

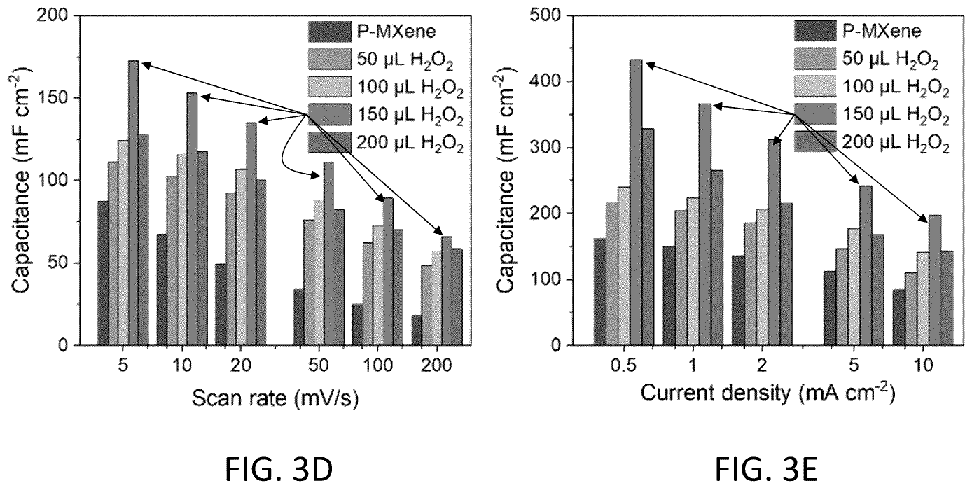

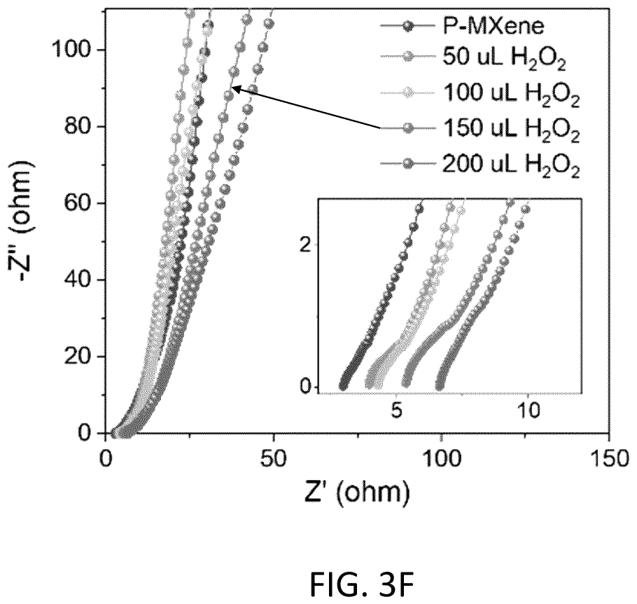

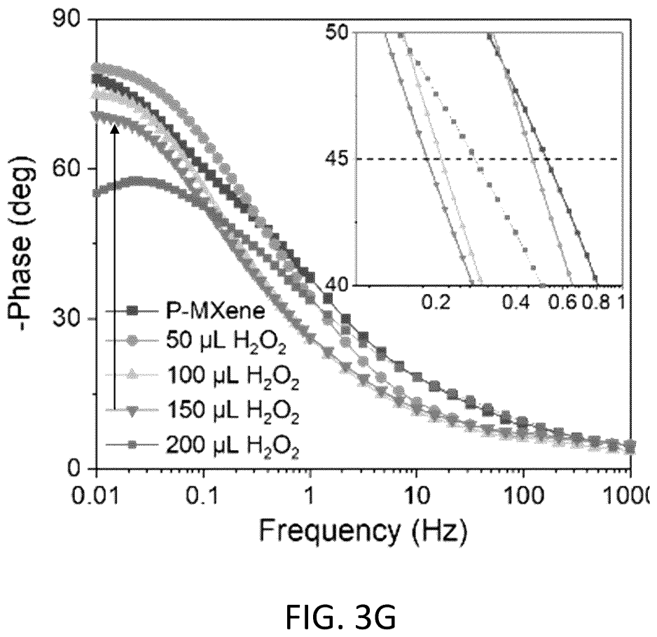

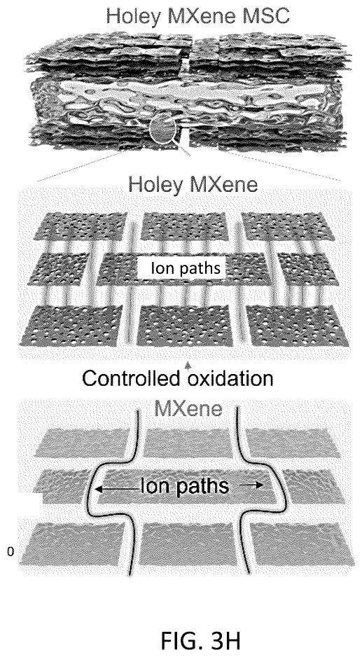

As also demonstrated in the Example, below, despite the decrease in conductivity of the electrode due to the holey Ti₃C₂Tₓ nanosheets and an increase in interface resistance between the PVA/H₂SO₄ electrolyte and the electrode, the supercapacitor of FIG. 6B exhibits a remarkable and surprising increase in capacitance as compared to a comparative supercapacitor including electrodes composed of comparative Ti₃C₂Tₓ nanosheets formed using the same technique as the holey Ti₃C₂Tₓ nanosheets but which have not been subjected to the disclosed oxidation treatment. (See FIGS. 3A-3E, wherein “P-MXene” refers to such comparative MXenes.) As illustrated in FIG. 3H, this significant improvement in performance is believed to be related to the greater number and shorter ion transport pathways provided by the holey Ti₃C₂Tₓ nanosheets as compared to electrodes composed of pristine Ti₃C₂Tₓ nanosheets.

Any of the present supercapacitors may be characterized as having a greater areal capacitance as compared to a comparative supercapacitor. The comparative supercapacitor refers to a supercapacitor having the same MXene, the same structure, fabricated the same way, and tested the same way except that the MXene has not been subjected to any of the disclosed oxidation treatments. The areal capacitance of the present supercapacitor may be at least 1.5 times greater, at least 2 times greater, at least 2.5 times greater, at least 3 times greater, or a range between any of these values, than the areal capacitance of the comparative supercapacitor. This comparison may refer to the measurement of the areal capacitance at a specific current density and/or scan rate, including any of those used in the Example, below.

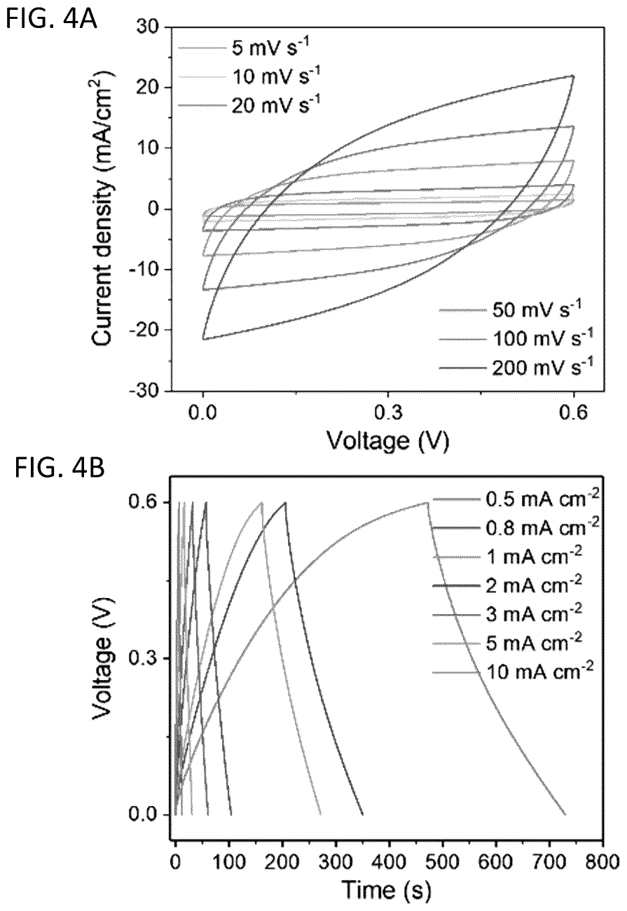

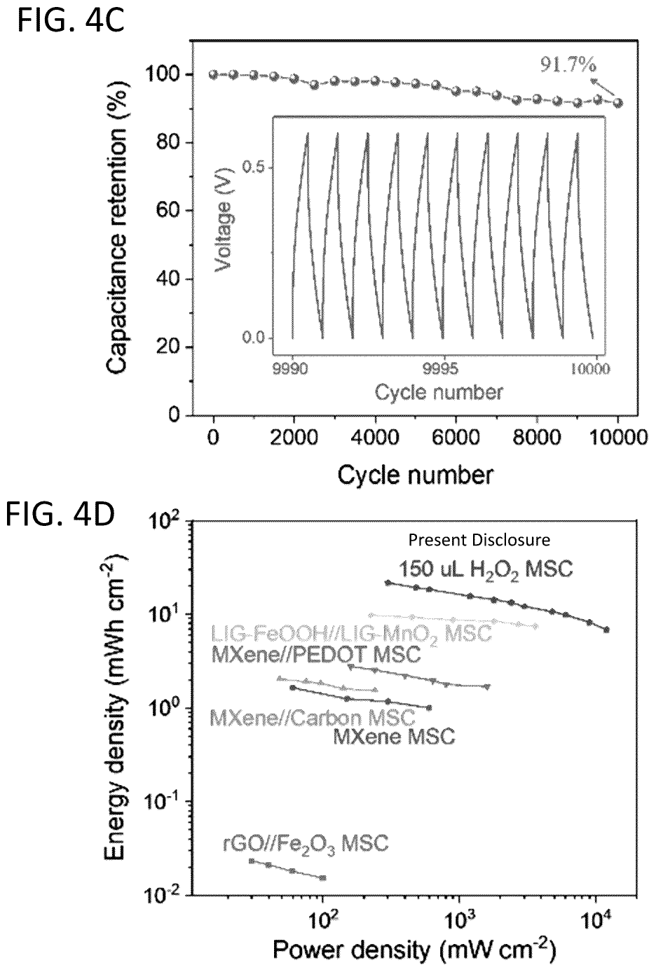

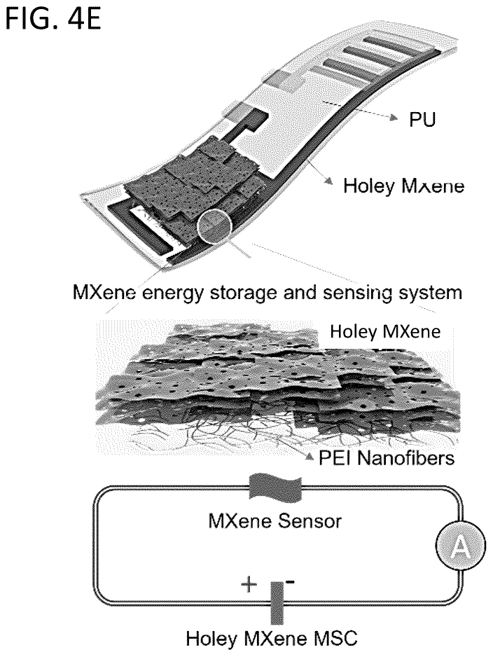

The present electrodes and energy storage devices comprising the electrodes may be used in any device, system, or application in which electrodes and energy storage devices are used. For example, an illustrative system is shown in FIG. 4E. The system comprises the supercapacitor of FIG. 6B (labeled “Holey MXene MSC” in FIG. 4E) in electrical communication with a sensor. This sensor may also include any of the disclosed holey MXene nanosheets, which may be, but need not be, of the same type as the holey MXene nanosheets of the energy storage device. In this embodiment, the sensor (labeled “MXene Sensor” in FIG. 4E) comprises a sensing layer comprising holey Ti₃C₂Tₓ nanosheets and an isolation layer comprising a plurality of polyethyleneimine (PEI) nanofibers forming an interface with the sensing layer. Other isolation layers may be used. A coating of polyurethane is disposed on the sensor and the supercapacitor.

Energy storage devices and systems may comprise multiple pairs of the present electrodes which may be arranged in parallel or series as described in the Example, below.

### EXAMPLE

### Introduction

This Example describes the design of an oxidation treatment for MXene (here, Ti₃C₂Tₓ) for high-performance energy storage electrodes. This Example systematically explores how controlled oxidation optimizes the electrochemical properties of MXenes. The oxidized MXene nanosheets were analyzed, and the conditions required to create nanosized holes therein were identified. Surprisingly, it was found that the nanosized holes significantly enhanced the electrochemical energy storage capacity of the MXene-based electrodes. Thus, the approach is shown to expand the applications of MXenes in electrochemical energy storage applications.

### Experimental Section

Synthesis of MXene Nanosheets: MXene nanosheets were synthesized via wet etching of MAX phase (Ti₃AlC₂) in a ventilated fume hood. Initially, 1 g of MAX phase precursor and 1 g of LiF powder were weighed. The LiF powder was then added to 20 mL of 9 M HCl and thoroughly stirred. The MAX phase powder was gradually introduced in portions while maintaining continuous stirring. The reaction typically proceeded at 35° C. for 24 hours, during which aluminum atoms in Ti₃AlC₂ were selectively etched away, forming MXene (Ti₃C₂Tₓ), where T represents surface termination groups such as —OH, —O, and —F. After reaction, the resulting suspension was repeatedly centrifuged and washed with deionized water approximately 5 times until the pH of the supernatant reached near neutrality (pH~6-7). The centrifugation was conducted at 3500 rpm for 5 minutes per cycle. The supernatant, containing dispersed MXene nanosheets in water, was then collected. Finally, the obtained MXene nanosheet solution was filtered for concentration calibration and stored in a refrigerator.

### Synthesis of H-MXene Nanosheets

The quantified MXene solution was diluted to a concentration of 2 mg/ml. Next, varying amounts of H₂O₂ (50 μL, 100 μL, 150 μL, or 200 μL) were added to 200 mL of the MXene solution. The mixture was continuously stirred for 30 minutes. After stirring, the solution underwent multiple rounds of centrifugation and washing. Finally, the solution was subjected to ultrasonication for 5 minutes in an ice bath to obtain the H-MXene nanosheet solution.

### Preparation of MXene Electrochemical Micro-Supercapacitors (MSCs) and An Integrated Energy Storage and Sensor System

The final MXene solution was subjected to ultrasonic filtration to produce MXene membranes, which were then laser-engraved to form MXene electrochemical electrodes. PVA was dissolved in a water bath at 98° C. until a clear, transparent solution was obtained. H₂SO₄ was then added to form the PVA/H⁺ gel electrolyte. This gel electrolyte was spin-coated onto the MXene electrodes and encapsulated with self-healing PU.

For the integrated energy storage and sensor system, MXene electrodes were patterned using laser engraving. 4 g of PEI pellets were dissolved in 10 mL of 1-methyl-2-pyrrolidinone (NMP, Aladdin, 99.9%) at 40° C. for 48 hours. The resulting stable solution was loaded into a syringe and electrospun using an ET-2535D device with an electric field of 1.2 kV cm⁻¹ and a syringe pump flow rate of 1 mL h⁻¹. As an isolation layer, the electrospun nanofiber PEI was deposited onto the electrode, with the MXene film serving as the sensing layer, and the entire system was encapsulated with PU.

### Characterizations and Measurements

The morphologies of the MAX phase and MXene nanosheets were characterized using an FEI Quanta 650 scanning electron microscope (SEM). Cross-sectional TEM samples of the MXene were prepared with a focused ion beam using an FEI Helios FIB/SEM. The structure and in-plane porosity of the MXene nanosheets were examined using a JEOL ARM200CF which was equipped with a probe corrector. The thickness of MXene nanosheets was measured using a Bruker ICON atomic force microscope (AFM). Changes in the interlayer structure were analyzed via X-ray diffraction (XRD) using a PANalytical B.V. Empyrean system. BET (Brunauer-Emmett-Teller) surface area measurements and BJH (Barrett-Joyner-Halenda) pore size distribution analyses were conducted on a Micromeritics 3Flex Adsorption Analyzer. To improve the accuracy of the adsorption isotherm, the samples were degassed by heating at a specific temperature (e.g., 100° C.) under dynamic vacuum on a MicroMiretics ASAP 240 to remove moisture and other volatile substances from the sample surface. Microsupercapacitor (MSC) devices were fabricated through laser engraving, electrostatic spinning, and encapsulation. The electrochemical performance of the MSCs was assessed using the CHI 760e electrochemical workstation. The sensing performance of the integrated sensing and energy storage system was evaluated using an Agilent B2091A source meter.

### Areal Capacitance, Energy Density, Power Density Calculations

Areal capacitance (Cₐᵣₑₐₗ) is calculated from the cyclic voltammetry curve according to the following formula:

$${C}_{a r e a l} = A / ( 2 \times S \times Δ U \times Δ S )$$

where ΔS is the total area of the electrodes, A is the area framed by the C-V curve, S is the scan rate, ΔU is the potential window.

Areal capacitance (Cₐᵣₑₐₗ) is calculated from the charge-discharge curve according to the following equation:

$${C}_{a r e a l} = I \times Δ t / ( Δ U \times Δ S )$$

where ΔS is the total area of the electrodes, I is the discharge current, Δt is the discharge time, and ΔU is the potential window during the discharge process.

The energy density (E) and power density (P) of the device can be calculated from the galvanostatic charge-discharge curve according to the following formulae:

$$E = ( 1 / 7200 ) \times {C}_{r e a l} \times Δ {U}^{2}$$

$$P = ( E \times 36 \; 00 ) / Δ t$$

### Regulation of H-MXene and Fabrication of MSCs

High-quality MXene nanosheets were first obtained using a wet etching (HCl and LiF) process and then H-MXene was obtained through controlled oxidation. As illustrated in FIG. 1A, the porous structure within the MXene nanosheets was achieved through a carefully managed mild oxidation process, followed by meticulous cleaning. The transmission electron microscopy (TEM) image of the pristine MXene nanosheet (FIG. 1B) revealed a defect-free thin-layered structure. The corresponding selected area electron diffraction (SAED) pattern (FIG. 1C) showed the [001] zone axis of hexagonal structure, with a d-spacing of 0.286 nm for the (010) plane. After partial oxidation, the TEM image and SAED pattern (FIGS. 1D and 1E) showed the formation of numerous pores within the nanosheets, and the d-spacing of the (010) plane was reduced to 0.257 nm.

Notably, excessive oxidation can lead to the degradation of MXene. In other images not shown, MXene, H-MXene and fully oxidized MXene solutions all exhibited a pronounced Tyndall effect. The TEM image in FIG. 1F shows that the originally smooth MXene nanosheets transformed into a collection of numerous individual, discrete nanoparticles upon excessive oxidation. The SAED patterns shown in FIGS. 1G-1I confirm the presence of a polycrystalline structure corresponding to TiO₂ (Anatase, space group: I4₁/amd) in MXene nanosheets subject to excessive oxidation. Specifically, the electron diffraction data in FIG. 1H displayed distinct polycrystalline rings, and the integrated intensity of the (101) ring became more prominent while the (004) and (200) rings gradually weakened, consistent with the polycrystalline diffraction data of TiO₂ shown in FIG. 1G.

The quality of the precursor MAX phase is critical for producing efficient MXene electrodes. The SEM images in FIG. 2A show the multilayered structure of bulk Ti₃AlC₂ MAX phase. As shown in the SEM images of FIG. 2B, pristine MXene nanosheets (P-MXene) prepared using a wet etching process exhibited a dispersed, layered configuration, resulting in single-layer or few-layer MXene nanosheets. A statistical analysis of the size distribution revealed an average size of 3.8 μm among 250 nanosheets, with sizes ranging from 1.6 μm to 9.1 μm. Additionally, atomic force microscopy (AFM) confirmed the monolayer structure of the MXene, showing a thickness of approximately 1.55 nm (see FIG. 2C. Elemental maps of the MXene nanosheets were also obtained (data not shown).

The H-MXene nanosheets were subsequently fabricated through partial oxidation. By varying the volumes of H₂O₂ over identical time frames, the density and dimensions of the in-plane nanosized pores were regulated. Morphological characterizations of H-MXene oxidized with different volumes of H₂O₂ were performed using TEM. For example, TEM images showed the emergence of nanoscale pores on the surface of the MXene nanosheets using 50 μL H₂O₂. Quantitative testing showed that the porosity of MXene oxidized with 50 μL H₂O₂ was ~5.8% by volume. As the amount of H₂O₂ increased to 100 μL, 150 μL, and 200 μL, the porosity of MXene nanosheets significantly increased to ~9.2%, 15.8%, and 26.3%, respectively (FIG. 2D and other data not shown). Quantitative BET (Brunauer-Emmett-Teller) and BJH (Barrett-Joyner-Halenda) pore analyses were conducted. BET surface areas of samples are shown in FIG. 7A and the pore size distributions are shown in FIG. 7B. The results show that H-MXene has a higher specific surface area, although a decrease in specific surface was observed using decreased when using 200 μL of H₂O₂, likely due to structural degradation of MXene. Pore volume increased as the amount of oxidation increased.

Next, the electrochemical performance of H-MXene samples was evaluated. Supercapacitors (referred to as MSCs) with electrodes made from MXenes subjected to various oxidation treatment conditions were fabricated and tested. Interdigitated electrodes were used to enhance electrode utilization. FIGS. 6A and 6B illustrate the fabrication process of MSCs using micro-nanofabrication techniques. The laser-etched electrodes prepared from H-MXene are shown in FIG. 2E. The distinct gaps between the electrodes prevented short circuits, while the interdigitated design maximized the specific surface area. The upper right corner of FIG. 2E shows a top-view image of the entire H-MXene interdigitated electrode. Integrated electrodes for energy storage and sensing were also fabricated, in which the energy storage unit powered the sensing unit. Additionally, SEM analysis was performed on the polyethyleneimine (PEI) nanofiber isolation layer used in the integrated energy storage sensor system (data not shown). To study the interlayer structure of the MXene nanosheets, focused ion beam (FIB) was used to prepare a cross-sectional TEM specimen of the H-MXene electrodes (images not shown). The FIG. 2F scanning transmission electron microscopy (STEM) high angle annular dark-field (HAADF) image of a H-MXene cross-section revealed a clear interlayer structure with a spacing of 18.48 nm within a 15 H-MXene layer structure, resulting in an interlayer spacing of approximately 1.23 nm. To gain a comprehensive understanding of the interlayer spacing of H-MXene across various oxidation conditions, X-ray diffraction (XRD) analyses were conducted (data not shown). The results revealed that the (002) peak of H-MXene gradually shifted to higher angles with increasing H₂O₂ concentrations, indicating a subtle reduction in interlayer spacing.

Flexible energy storage devices have garnered significant attention due to the growing demand for wearable electronics, which require power sources that are lightweight, durable, and adaptable to various shapes. Flexible MSCs offer unique advantages, such as high mechanical flexibility, low weight, and the ability to integrate seamlessly into wearable systems. FIGS. 2G and 2H illustrate the concept of using a flexible MSC for energy storage in wearable electronic devices, to provide power. The MSCs consisted of symmetric H-MXene electrodes, with one electrode connected to the working electrode and the other to both the counter and reference electrode, providing energy for a sensor or other flexible electronics. As shown in FIG. 2G, the MSC included H-MXene electrodes, a gel electrolyte composed of polyvinyl alcohol (PVA) with proton (H⁺) conductivity, and polyurethane (PU) overcoat. During the charging process, protons migrated to the negative H-MXene electrode, while sulfate ions (SO₄²⁻) moved to the positive electrode, accumulating on the surface of each H-MXene nanosheet layer, forming a double electric layer to store energy. The discharge process occurred in reverse.

Electrochemical Performance of H-MXene MSCs with Varied Porosities.

In this section, the electrochemical performance of capacitors using H-MXene electrodes having different degrees of oxidation will be discussed. FIGS. 3A and 3B show the cyclic voltammetry (CV) and galvanostatic charge-discharge (GCD) curves from the different types of MXene nanosheets, respectively. Specifically, curves from MXene nanosheets oxidized using the different amounts of H₂O₂, including 50 mL, 100 mL, 150 mL, and 200 mL, are shown. The control, comparative MXene nanosheet is referred to as “P-MXene.” The CV curves exhibited distinctive rectangular shapes and nearly symmetric charge-discharge profiles, indicating that energy storage using MXene primarily relied on the double-layer capacitance effect. The electrochemical performance of MSCs made from H-MXene surpassed that of MSCs made from P-MXene. As the volume of the oxidizing agent H₂O₂ increased to 150 μL, the area enclosed by the CV curves and the discharge time both increased. This curve is labeled in both FIGS. 3A and 3B. However, further increasing the H₂O₂ volume to 200 μL led to a decrease in electrochemical performance, as excessive oxidation reduced the electrochemical energy storage capacity.

The areal capacitance of the MSCs was further quantitatively examined at various current densities, as depicted in FIG. 3C and other data not shown. The MSCs made from H-MXene treated with 150 μL of H₂O₂ consistently exhibited the highest areal capacitance across both low and high current density ranges (this curve is labeled in FIG. 3C), followed by the those treated with 200 μL H₂O₂, 100 μL H₂O₂, 50 μL of H₂O₂. At a current density of 2 mA cm⁻², the MSCs made from H-MXenes treated with 150 μL H₂O₂ achieved an areal capacitance of 433.3 mF cm⁻², which is 2.5 times greater than that of the MSCs made from P-MXene without pores (171.6 mF cm⁻²). Even at higher current densities, the 150 μL H₂O₂-treated H-MXene MSCs still outperformed all other MXene MSCs. FIGS. 3D and 3E show the capacitance of all MSCs at different scan rates and current densities. All H-MXenes demonstrated higher capacitance across various scan rates and current densities as compared to P-Xene.

As shown by the Nyquist plot of electrochemical impedance spectroscopy (EIS) (FIG. 3F), the nanosized pores led to a slight decrease in MXene conductivity and an increase in the interface resistance between the electrolyte and the electrode. FIG. 3G presents the corresponding Bode phase plot. According to the formula τ₀=1/f₀, the relaxation time constants (τ₀) at 450 for MSCs fabricated using P-MXene, and H-MXene treated with 50 μL, 100 μL, 150 μL, and 200 μL of H₂O₂ were 1.92 s, 2.17 s, 4.76 s, 5.41 s, and 3.57 s, respectively. As the degree of oxidation increased, the relaxation time increased first and then decreased. Despite the slight increase in resistance and decrease in ionic conductivity as the amount of H₂O₂ increased to 150 μL, H-MXene nanosheets still provided high capacitance due to the reduced ion transport path and the presence of more active sites. This improved energy storage performance was attributed to the formation of the nanoscale holes.

The schematic shown in FIG. 3H illustrates the mechanism of ion transport in the H-MXene nanosheets. Specifically, in the charge-discharge process, ions shuttle between the electrodes at the interface at which MXene electrodes contact the electrolyte. In the untreated P-MXene nanosheets, the ion transport channels in P-MXene are long and tortuous (bottom image). After controlled oxidation to produce substantial nanosized holes, the number of ion transport channels significantly increased while their length shortened (middle image). The increased number of channels and shorter pathways facilitates ion diffusion, effectively reducing ion transport distances and enhancing ion transport efficiency. Therefore, contrary to the conventional belief that the oxidation of MXenes was expected to be detrimental, this Example shows that oxidation can be controlled and then leveraged to manufacture higher-performance MXene energy storage electrodes by exploiting the ion transport channels created during the process.

### Performance of the Integrated Sensing System Made Using H-MXene MSCs

To further elucidate the superior energy storage performance of H-MXenes, a comprehensive set of analyses was conducted on MSCs fabricated using H-MXene treated with 150 μL of H₂O₂. As described above, this treatment resulted in the best energy storage capacity. The CV curves depicted in FIG. 4A, acquired at various scan rates, demonstrate a commendable level of reversibility. FIG. 4B shows the GCD curves at different charge-discharge rates, exhibiting nearly symmetrical profiles, further corroborating the favorable reversibility of the MSCs made from H-MXenes. Notably, the device demonstrated a discharge duration of 259 seconds at a charge-discharge rate of 0.5 mA cm⁻². Even under a more demanding rate of 3 mA cm⁻², the MSCs sustained a discharge duration of 28 seconds, underscoring their exceptional electrochemical energy storage performance. The quantitative ratio of surface capacitive and diffusion contributions at different scan rates were obtained (data not shown). As the scan rate increased, the surface capacitive contribution gradually dominated. At a high scan rate of 200 mV/s, the diffusion-controlled contribution was 31.4%, indicating that the porous structure of H-MXene still facilitated ion diffusion at high scan rates. This diffusion process impacted the capacitive behavior, demonstrating that even at high scanning speeds, the structural characteristics of H-MXene can effectively support ion transport, thereby enhancing its energy storage performance. This feature is especially advantageous in fast charge-discharge applications, making H-MXene an advantageous material for high-efficiency energy storage devices. The self-discharge performance of the 150 μL H₂O₂-treated H-MXene MSC under open-circuit conditions was evaluated (data not shown). After a relatively rapid initial self-discharge rate of 45.83 mV/min in the first stage, the device maintained an ultra-low rate of 0.167 mV/min, effectively preserving its capacity over an extended period.

To assess the long-term stability of the device, a cyclic stability test was performed. The results are shown in FIG. 4C. Remarkably, the MSCs made from H-MXene treated with 150 μL of H₂O₂ retained 91.7% of their initial capacitance after 10,000 charge-discharge cycles, substantiating their outstanding cyclic stability and viability for prolonged use. FIG. 4D compares results from the MSCs made from H-MXene treated with 150 μL of H₂O₂ with existing MSCs, unequivocally demonstrated the superior performance of the present MSCs

Due to the ultra-high electrochemical energy storage capacity of H-MXene MSCs, they can effectively be used as a power supply for various microelectronic devices. This makes them highly suitable for integration into multifunctional systems, providing both energy storage and operational power. To this end, an integrated device combining energy storage and sensing functionalities was fabricated, as shown in FIG. 4E. This integrated architecture uses a MSC coupled with a pressure-sensing unit, consisting of an H-MXene sensing layer, a nanofiber PEI insulating layer, and integrated H-MXene interdigitated electrodes. Testing of the pressure detection capabilities of this integrated system yielded promising results. Specifically, when subjected to periodic pressure application and release, the sensor exhibited a current response corresponding to the pressure fluctuations, with the current response increasing as the pressure intensified (data not shown). The sensor showed a sensitivity of 67.36 kPa⁻¹ in the range of 0.92 to 6.21 kPa (data not shown). Subsequently, a cyclic pressure test was performed on the system. The device displayed excellent cyclic stability after 1000 cycles, with only a minor decay of about 3.7% in the pressure test (data not shown). During the pressure holding phase, the interlayer structure of MXene exhibited a certain degree of recoverability, leading to a gradual decline in the output signal of the sensor. However, this phenomenon did not compromise the sensitivity of the sensor to pressure variations. Additionally, the integrated device can be placed at the human joint to detect finger bending (data not shown). These results confirm that the devices can be used in integrated circuits, providing both energy storage and power supply for the pressure sensor or circuits

### Flexibility of H-MXene MSCs

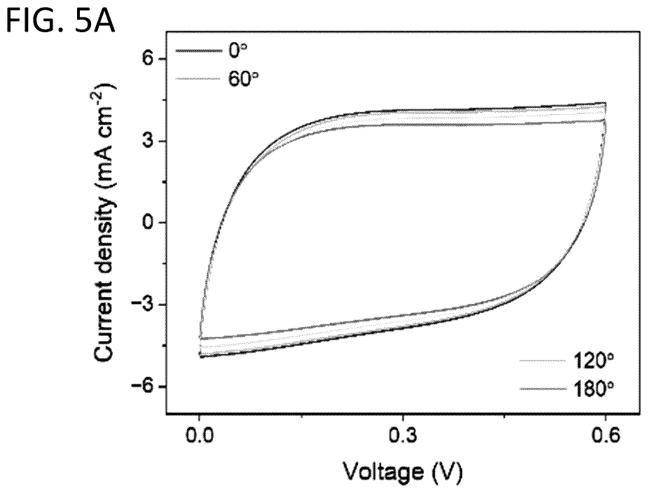

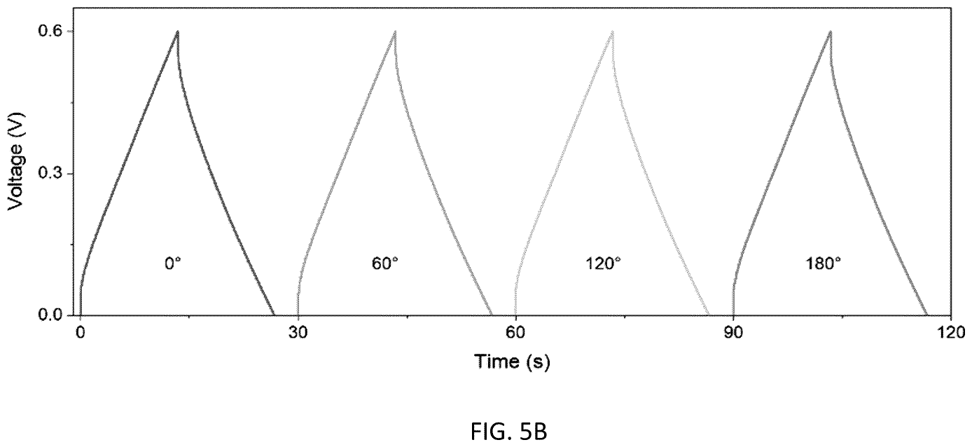

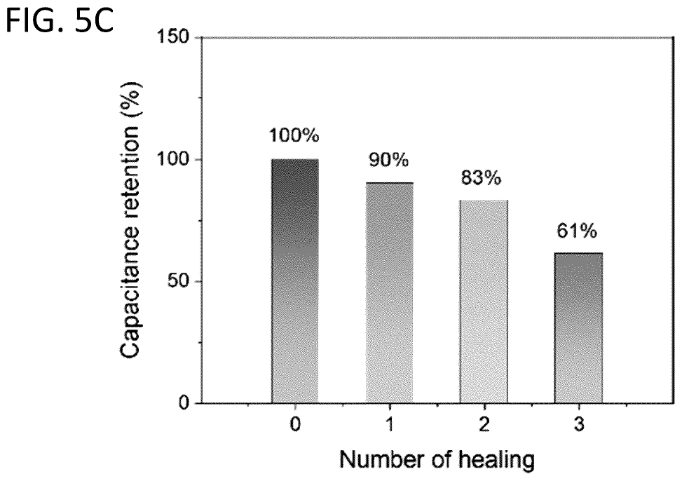

To investigate the resilience and scalability of the MSCs, bending tests were conducted. As shown in FIGS. 5A and 5B, the CV and GCD curves demonstrate that the MSCs exhibited excellent flexibility, with only minor capacity losses observed when bent at angles of 60°, 120°, and 180°. Furthermore, the scalability of the MSC was explored by fabricating MSCs connected in series and parallel, and they were compared to two individual MSCs. The parallel-connected MSCs exhibited a significant increase in areal capacitance, while the series-connected MSCs achieved a voltage window of up to 1.2V (data not shown).

The flexibility of the devices not only enabled seamless integration into various wearable electronic systems but also enhanced its durability under mechanical stress. Additionally, the incorporation of self-healing PU into the devices provided self-repair capabilities, ensuring long-term performance and reliability even after physical damage. Experiments revealed that devices can re-bond after being severed and withstand a weight of 50 g post self-healing. The electrochemical performance of the MSCs was then tested before and after self-healing. As shown in FIG. 5C, the MSCs exhibited optimal electrochemical performance before being broken (number of healing=0), with the highest energy storage capacity and longest discharge time. After one break and self-healing cycle, the electrochemical performance slightly decreased, with the discharge time reduced and the electrochemical capacity maintained at approximately 90% of the initial value, still maintaining good energy storage capabilities. After two break- and self-healing cycles, the electrochemical retention was about 83% of the initial value. Following three break and self-healing cycles, the MSCs' electrochemical performance significantly declined, with the discharge time greatly shortened and the capacity reduced to only 61% of the initial value. These results confirm that the self-healing PU provided MSC devices with excellent self-repair capabilities, allowing them to retain substantial electrochemical performance after repair. This enhanced the devices' applicability in scenarios requiring resistance to mechanical damage and adaptation to complex environmental changes.

### CONCLUSION

Oxidation is typically regarded as detrimental to the functional performance of MXenes. However, in this Example, oxidation was controlled and harnessed to fabricate H-MXene nanosheets with numerous in-plane nanosized pores, significantly and unexpectedly enhancing their electrochemical performance. By precisely controlling the degree of oxidation, the density of in-plane pores was regulated within the MXene nanosheets, which functioned as ion channels. These channels effectively reduced ion transport distances and improved transport efficiency, leading to a marked enhancement in electrochemical energy storage capacity. MSCs made from H-MXenes demonstrated exceptional electrochemical performance, with areal capacitance reaching 2.5 times that of the original, pristine MSC, and exhibited excellent cycling stability, retaining 91.7% of their capacitance after 10,000 cycles. Moreover, a flexible integrated system combining energy storage and sensing capabilities was developed, enabling self-powered sensing tests. This system can detect pressure signals, enabling the monitoring of human physiological signals. The scalability of the MSCs was also explored, showing that their electrochemical capacity can be significantly enhanced through series or parallel connections, providing more energy to devices by integrating multiple MSCs. The incorporation of self-healing PU endowed the device with self-healing capabilities, allowing it to retain 90% of its initial capacity after one break-heal cycle and maintain electrochemical storage ability even after multiple self-healing cycles.

Additional information, including that indicated as being not shown may be found in U.S. Provisional Patent Application No. 63/760,054 filed on Feb. 18, 2025, the entire disclosure of which is incorporated by reference.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.” Terms such as “comprising” may be replaced with terms such as “consisting.”

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

Unless otherwise indicated, and in recognition of the inherent nature of the techniques described herein, throughout the present disclosure, terms and phrases such as “absence,” “free,” “does not comprise,” etc. encompass, but do not require a perfect absence of the referenced entity.

Unless otherwise indicated, the term “type” as used herein refers to chemical formula such that a single type means the same chemical formula and different type means different chemical formula. Similarly, use of “more” as in “one or more types” refers to use of different types of the relevant entity. Similarly, terms such as “same” and the like, encompass, but do not require an exact correspondence of the referenced parameter/property (in recognition of the inherent nature of the techniques described herein).

Unless otherwise indicated, throughout the present disclosure, terms such as “comprising” and the like may be replaced with terms such as “consisting” and the like.

What is claimed is:

1. A composition comprising a plurality of holey MXene nanosheets, each holey MXene nanosheet composed of one or more monolayers of MXene, wherein surfaces of the MXene define a plurality of nanoscale holes distributed laterally throughout each holey MXene nanosheet.

2. The composition of claim 1, wherein the MXene has a formula Mₙ0.1XₙTₓ.

3. The composition of claim 2, wherein the formula is Mₙ+1CₙTₓ, wherein M is selected from Ti, V, Cr, Nb, and combinations thereof.

4. The composition of claim 3, wherein the MXene is Ti₃C₂Tₓ.

5. The composition of claim 1, wherein each holey MXene nanosheet in the plurality of holey MXene nanosheets has, on average, no more than 5 MXene monolayers.

6. The composition of claim 1, wherein the plurality of nanoscale holes has an average diameter in a range of from 1 nm to 100 nm.

7. The composition of claim 1, wherein the plurality of holey MXene nanosheets has a surface area that is at least 2 times greater than that of a plurality of pristine MXene nanosheets.

8. The composition of claim 1, wherein the plurality of holey MXene nanosheets has a surface area of at least 15 m²/g and a porosity in a range of from 10% to 25%.

9. The composition of claim 1, wherein the plurality of nanoscale holes has an average diameter in a range of from 1 nm to 100 nm, and the plurality of holey MXene nanosheets has a surface area of at least 15 m²/g and a porosity in a range of from 10% to 25%.

10. An energy storage device comprising an electrode comprising the composition of claim 1, an electrolyte forming an interface with a surface of the electrode, and a counter electrode in electrical communication with the electrode.

11. The energy storage device of claim 10, wherein the counter electrode comprises the plurality of holey MXene nanosheets.

12. The energy storage device of claim 10, characterized by an areal capacitance that is at least 2 times greater than that of a comparative energy storage device comprising a plurality of pristine MXene nanosheets.

13. An electrochemical system comprising the energy storage device of claim 10 and a sensor in electrical communication with the energy storage device.

14. The electrochemical system of claim 13, wherein the sensor comprises a sensing layer comprising the plurality of holey MXene nanosheets; and an isolation layer forming an interface with the sensing layer.

15. A method of fabricating the composition of claim 1, the method comprising exposing MXene nanosheets composed of one or more monolayers of MXene to an oxidizing agent under conditions to induce formation of nanoscale holes distributed laterally throughout the MXene nanosheets, thereby providing the plurality of holey MXene nanosheets.

16. The method of claim 15, wherein the oxidizing agent is a peroxide.

17. The method of claim 16, wherein the oxidizing agent is H₂O₂.

18. The method of claim 16, wherein the exposing step comprises use of the peroxide at a concentration in a range of between 7.5 mM and 11.5 mM.

19. The method of claim 18, wherein the exposing step is carried out at room temperature.

20. The method of claim 15, further comprising forming a membrane from a plurality of the holey MXene nanosheets and patterning the membrane to provide one or more electrodes comprising the plurality of the holey MXene nanosheets.
